(19) United States
(12) Patent Application Publication
(10) Pub. No.: US 2008/0088600 A1
(43) Pub. Date: Apr. 17, 2008

(54) Method and apparatus for implementing multiple push buttons in a user input device

(75) Inventors: Christopher D. Prest, Mountain View, CA (US); Fletcher Rothkopf, (US); Richard H. Dinh, San Jose, CA (US); Tang Tan, San Francisco, CA (US)

Correspondence Address: APPLE c/o MOFO NOVA, 1650 TYSONS BLVD., SUITE 300, MCLEAN, VA, 22102, US

(73) Assignee: Apple Inc., Cupertino, CA (US)

(21) Appl. No.: 11/878,132

(22) Filed: Jul. 20, 2007

Related U.S. Application Data
(60) Provisional application No. 60/850,662, filed on Oct. 11, 2006.

(51) Int. Cl. G06F 3/041

(52) U.S. Cl. 345/173

(57) ABSTRACT

Method and apparatus for implementing multiple push buttons in a user device are disclosed. The method includes detecting a location of a user input using one or more touch sensors, detecting a force of the user input using a switch, and generating a signal for representing one of the push buttons being pressed according to with the location and force of the user input.

### CROSS-REFERENCE TO RELATED APPLICATIONS

This application claims the benefit of U.S. Provisional Application Ser. No. 60/850,662, filed Oct. 11, 2006.

### FIELD OF THE INVENTION

The present disclosure relates generally to user input devices. In particular, the present disclosure relates to method and apparatus for implementing multiple push buttons in a user device.

### BACKGROUND OF THE INVENTION

There are various styles of input devices used in consumer electronics. Operations performed by such input devices generally involve moving a cursor and making selections on a display screen. Some input devices include buttons, switches, keyboards, mice, trackballs, touch pads, joy sticks, touch screens, and the like. Each of these devices has advantages and disadvantages that are taken into account when designing the consumer electronic device. Buttons and switches are generally mechanical in nature and provide limited control with regards to the movement of a cursor (or other selector) and making selections. For example, they are generally dedicated to moving the cursor in a specific direction (e.g., arrow keys) or to making specific selections (e.g., enter, delete, number, etc.). In the case of some hand-held personal digital assistants (PDA), the input devices use touch-sensitive display screens. When using such screens, a user makes a selection by pointing directly to objects using a stylus or finger.

In portable computing devices such as laptop computers, the input devices are commonly touch pads. With a touch pad, the movement of an input pointer (i.e., cursor) corresponds to the relative movements of the user's finger (or stylus) as the finger is moved along a surface of the touch pad. Touch pads can also make a selection on the display screen when one or more taps are detected on the surface of the touch pad. In some cases, any portion of the touch pad may be tapped, and in other cases a dedicated portion of the touch pad may be tapped. In stationary devices such as desktop computers, the input devices are generally selected from mice and trackballs. FIGS. 1A-1C illustrate a conventional click wheel that may be used with an electronic device. FIG. 1A shows a top view of the click wheel 100 containing five mechanical switches 102 that implement five push buttons. FIG. 1B shows a top view of touch sensors located beneath the top surface of the click wheel. In this example, the touch sensors 104 consist of eight segments arranged in a ring-shaped configuration. FIG. 1C shows both the mechanical switches and the touch sensors.

One of the problems with this conventional click wheel is that as the size of the click wheel decreases, which is desirable in portable electronic devices such as MP3 players and cellular phones, it becomes increasingly difficult to fit multiple mechanical switches into the conventional click wheel. As shown in FIG. 1C, the space between two mechanical switches, indicated by arrow 106 may be very small, and may be difficult and costly to manufacture. On the other hand, it is not desirable to reduce the size of the mechanical switches to less than certain size because it would be hard for the users to feel the switch and thus would reduce the user experience. Another problem of this conventional click wheel is that the area underneath the click wheel may be crowded with both the mechanical switches and the touch sensors. Therefore, it may be difficult to route the signals from the mechanical switches through the touch sensors to a controller that processes the signals generated by the mechanical switches. Yet another problem of this conventional click wheel is that it provides only angular information but not the distance of the location of the user's input. However, if the user presses a location in between the center switch and one of the four peripheral switches, the conventional click wheel may not accurately determine which of the two switches the user intends to press.

Therefore, there is a need for methods and apparatuses for implementing multiple push buttons in a user device that address the problems of the conventional click wheel. And there is a need for an improved sensor configuration that addresses the problems of the conventional click wheel.

### BRIEF SUMMARY OF THE INVENTION

This disclosure relates to method and apparatus for implementing multiple push buttons in a user device. It addresses the issues encountered in miniaturization of a click wheel in a user device such as the cellular phone or MP3 player. The method for simulating multiple push buttons in a user input device can include detecting a location of a user input using one or more touch sensors, detecting a force of the user input using a mechanical switch, and generating a signal for representing one of the push buttons being pressed according to with the location and force of the user input. The touch sensors may include capacitive, resistive, surface acoustic wave, pressure, and optical sensors. The mechanical switch may include a gimbaled button having a gimbaled plate, a flexible member that is located beneath the gimbaled plate and may be configured to deform in response to the force of the user input, and a supportive surface arranged to support the flexible member and the gimbaled plate. A processor may be typically employed to generate a signal that represents one of the push buttons being pressed based on the location and force of the user input.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the following drawings. Like numbers are used throughout the figures.

FIGS. 1A-1C illustrate a conventional click wheel device.

FIGS. 2A-2D illustrate methods for implementing multiple buttons in an input device according to some embodiments of the present disclosure.

FIGS. 3A and 3B illustrate another method for implementing multiple buttons in an input device according to some embodiments of the present disclosure.

FIGS. 4A and 4B illustrate a method for implementing a group of buttons according to some embodiments of the present disclosure.

FIGS. 5A-5C illustrate sensor configurations for implementing multiple buttons in an input device according to some embodiments of the present disclosure.

FIGS. 6A-6C illustrate implementations of a gimbaled button in an input device according to some embodiments of the present disclosure.

FIGS. 7A-7C illustrate other implementations of an input device according to some embodiments of the present disclosure.

FIGS. 8A-8C illustrate operations of the click wheel device according to some embodiments of the present disclosure.

FIG. 9 illustrates an example of a simplified block diagram of a computing system according to some embodiments of the present disclosure.

FIG. 10 illustrates a simplified perspective diagram of an input device according to some embodiments of the present disclosure.

FIGS. 11A-11D illustrate applications of the click wheel device according to some embodiments of the present disclosure.

FIGS. 12A and 12B illustrate installation of an input device into a media player according to some embodiments of the present disclosure.

FIG. 13 illustrates a simplified block diagram of a remote control incorporating an input device according to some embodiments of the present disclosure.

### DETAILED DESCRIPTION OF THE INVENTION

Methods and systems are provided for implementing multiple buttons in a user input device. The following descriptions are presented to enable any person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the spirit and scope of the disclosure. Thus, the present disclosure is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

The representative embodiments described herein relate to devices that use signals from a movement indicator and a position indicator substantially simultaneously to generate a command. A platform mounted in a frame of the device can include sensors that can indicate the position of an object, such as a user's finger, in contact with the platform. In addition, a movement indicator on the device can detect movement of the platform relative to the frame. A user can depress the platform to generate a button command. Since the position of the activation force on the touch pad can be determined from the positional indicator, different button commands can be generated depending upon where on the platform the user depresses the platform.

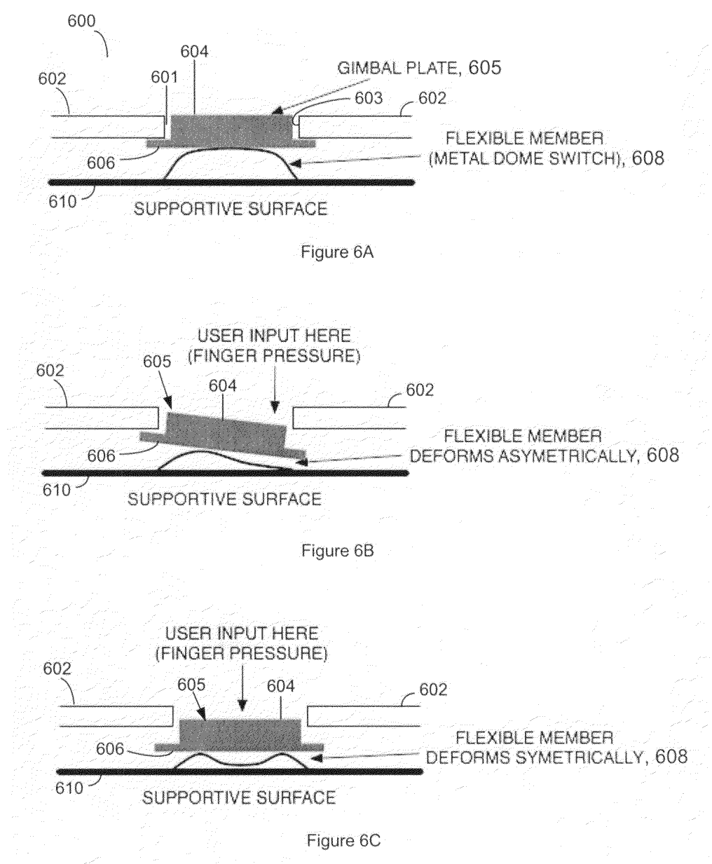

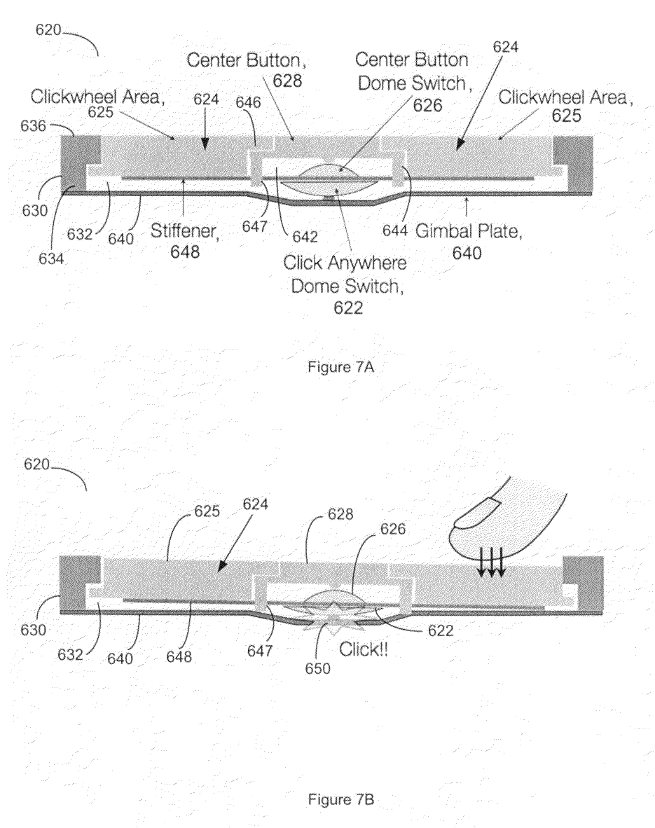

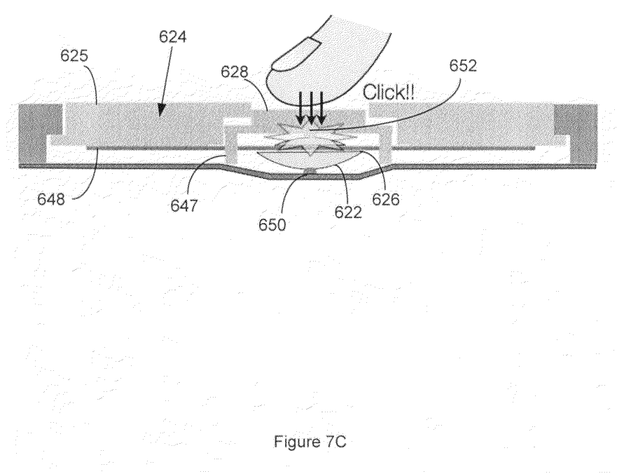

FIGS. 2A-2D illustrate methods for implementing multiple buttons in an input device according to some embodiments of the present disclosure. FIG. 2A shows a top view of an input device using a gimbaled button and object sensing devices. Outer circle 200 illustrates the bottom surface of the gimbaled button, and inner circle 201 illustrates the top surface of the gimbaled button. Detailed operations and cross-sectional views of the gimbaled button are described in association with FIGS. 6A-6C below. FIGS. 7A-7C describe another possible implementation of a gimbaled button according to embodiments of the present disclosure. The combination of the signals sensed by the gimbaled button and the touch sensors can provide information to the system about the intended controls the user wants to accomplish. FIG. 2B shows a possible configuration of object sensing devices located underneath the top surface of the gimbaled button. In this example, the object sensing devices include sixteen sensors 202 arranged along the side of the gimbaled plate, and sensor 204 located at the center of the gimbaled plate. Each of the sensors 202 may be electrically connected or separated, and sensors 202 and sensor 204 may be electrically separated by space 203. Note that an object sensing device may be used to refer to a variety of different sensing devices, including (without limitation) touch sensing devices and/or proximity sensing devices, such as touch pads, touch screens, etc.

In the embodiment shown in FIG. 2B, the sensor configuration can sense both angular information and radial distance information measured, for example, from the center of the gimbaled button. Using such angular and distance information, a click wheel device may be able to locate any position the user touches or presses.

According to some embodiments of the present disclosure, a polar coordinate system may be used to determine a position of a user input in an area. Each point in the polar coordinate system can be determined by two polar coordinates, namely the radial coordinate and the angular coordinate. The radial coordinate (usually denoted as R) denotes the point's distance from a central point known as the pole. The angular coordinate (also known as the polar angle, and usually denoted by θ) denotes the counterclockwise angle required to reach the point from the 0° polar axis of the polar coordinate system.

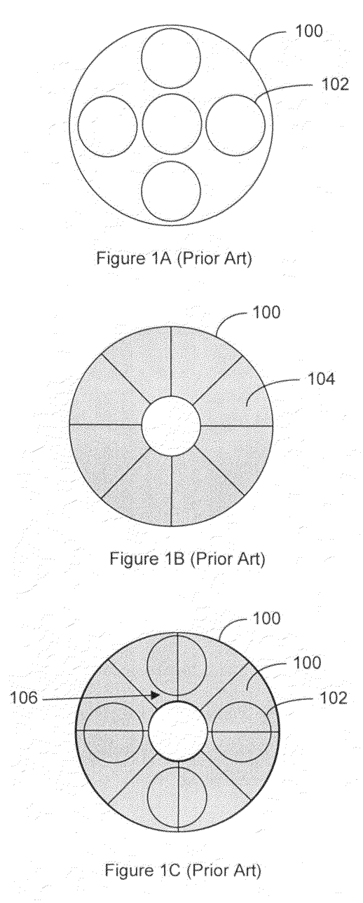

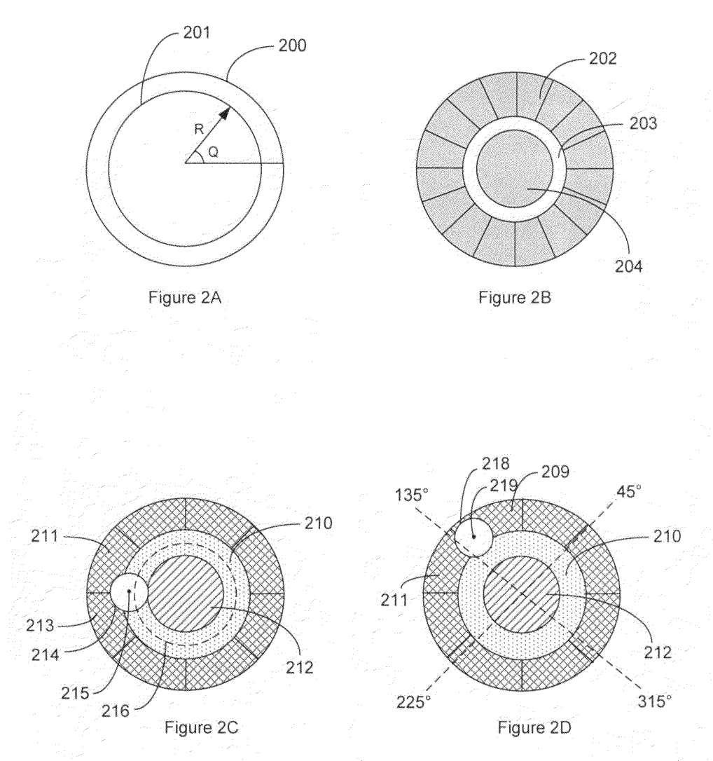

For example, if the sensors sense a location within close proximity of the polar coordinate (0, 0°) is touched or pressed, this sensed information may be used to indicate the center button is pressed. Similarly, if the sensors sense a location within close proximity of the polar coordinate (R, 0°), (R, 90°), (R, 180°), or (R, 270°) is pressed, the sensed information may be used to indicate that the right, top, left, or bottom button of FIG. 1A is pressed. Using this method, multiple push buttons may be emulated with a single switch (e.g. the gimbaled button) in combination with the set of touch sensors as shown in FIGS. 2A-2C.

Note that eight sensor segments are used in the example of FIG. 2B. In other implementations of the present disclosure, a different number of touch sensor segments, sixteen for example, may be used to implement the outer sensor ring. For example, to achieve 96 angular positions around the click wheel, one may use 8 sensor segments or 16 sensor segments. In either case, a number of separate angular positions, for example 96 angular positions, can be detected by interpolating sensor signals collected by 8, 16, or any other convenient number of sensors.

When a smaller set of sensors are used (e.g., 8), each sensor occupies a larger area and thus this sensor configuration may give a better signal-to-noise ratio. However, with this sensor configuration, there is a smaller number of sensors available from which to gather information. On the other hand, when a larger set of sensors are used (e.g., 16), each sensor can cover a smaller area, which means there is a larger number of sensors available for gathering information, and thus this sensor configuration may produce a better sensing resolution with a compromise on the signal-to-noise ratio of the sensors. Therefore, there can be a design trade-off between the size (and therefore the number) of sensors and the signal-to-noise ratio for any given configuration of sensors.

In designs where the sensors already produce a good signal-to-noise ratio, one may increase the number of sensors (i.e., reduce each sensor's area) for gathering finer resolution information generated by the sensors. In designs where the sensors have a poor signal-to-noise ratio, one may reduce the number of sensors (i.e., increase the area per sensor) for increasing the signal-to-noise ratio generated by the sensors.

FIG. 2C shows a method for determine radial accuracy of a user's press in a polar coordinate system according to some embodiments of the present disclosure. As shown in the example of FIG. 2C, sensors are arranged in three different regions, namely inner region 212, middle region 210, and outer region 202 of the gimbaled button. FIG. 2C also shows circle 214, which represents an area touched or pressed by the user, and centroid 215, which represents the center of circle 214 where the user has applied a force or pressure. To determine whether the center button or the left button is pressed by circle 214, one approach is to compute a threshold line, represented by dotted line 216, between the center button and the left button. In order to generate a left button press, centroid 215 would be outside threshold line 216, which is the case shown in FIG. 2C. To generate a center button press, centroid 215 would be inside threshold line 216 (not shown). Multiple threshold lines (not shown) may also be used in conjunction with threshold line 216 to provide different resolutions of the radial position of centroid 215 of the user's press.

FIG. 2D illustrates a method for determining angular accuracy of a user's press in a polar coordinate system according to some embodiments of the present disclosure. In this example, circle 218 represents proximity of an area touched by the user. To determine whether the top button or the left button is pressed by the circle, one approach is to identify the four quadrants marked by the dotted lines 45°, 135°, 225°, and 315°. For example, in order to generate a top button press, centroid 219, for example, would fall between the quadrant marked by the 45° and 135° lines in a counterclockwise direction. Similarly, the left button can be defined by the region between the 135° and 225° lines, the bottom button can be defined by the region between the 225° and 315° lines, and the right button can be defined by the region between the 315° and 45° lines. In other embodiments, a different number of regions may be defined to implement a different number of buttons within the sensor configuration. For example, six 60° regions may be used to implement six buttons along the outer ring of the click wheel, and eight 45° regions may be used to implement eight buttons along the outer ring of the click wheel, etc.

In other approaches, the method may further take into consideration the history of the user's finger (or the stylus) positions. For example, if the user's finger is previously recorded in a first region, the method may require the touch sensors to establish the user's finger has moved to a second region before a button press in the second region may be confirmed. In this manner, errors introduced by sudden jitters or a slippery finger may be avoided.

Note that in FIG. 2C, signals from sensors 211, 213, and 210 may be used to interpolate the distance of centroid 215 of the finger from the center of the polar system. Signals from secondary neighbor sensors, such as from center sensor 212, may also be used. Similarly, in FIG. 2D, signals from the immediate neighbor sensors 209, 210, and 211 may be used to interpolate the angular position of centroid 219 of the finger from the 0° polar axis. Signals from secondary neighbor sensors, such as from center sensor 212, may also be used to interpolate the angular position of centroid 219.

Other examples of a touch pad based on polar coordinates are described in U.S. Pat. No. 7,046,230, entitled “Touch Pad for Hand-held Device,” which is incorporated by reference herein in its entirety.

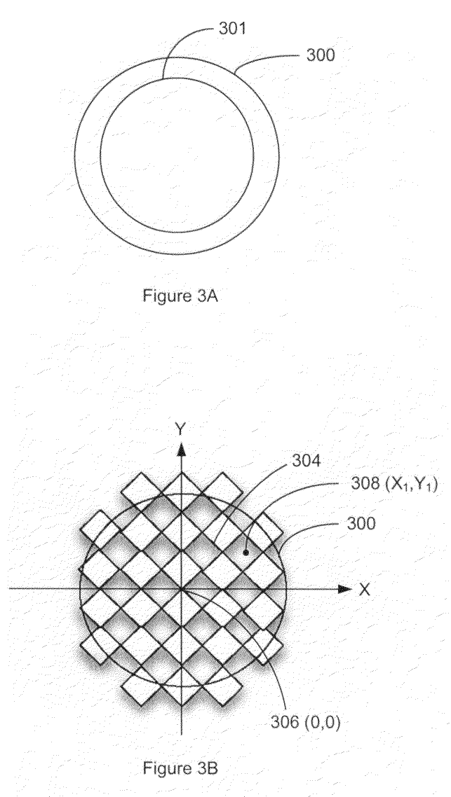

FIGS. 3A and 3B illustrate another method for implementing multiple buttons in an input device according to some embodiments of the present disclosure. FIG. 3A shows a gimbaled button with outer circle 300 representing the bottom surface of the gimbaled button and inner circle 301 illustrating the top surface of the gimbaled button. FIG. 3B illustrates a method for sensing a user's finger (or stylus) using sensors arranged in a two-dimensional grid. In one example, the two-dimensional grid may implement an X-Y grid for determining the position (or centroid) of the user's finger (or stylus).

As shown in FIG. 3B, the X-Y grid in a two dimensional coordinate system may be defined by two axes, for example at right angles to each other, forming a plane (an x-y plane). The horizontal axis is normally referred to as the x-axis, and the vertical axis is normally referred to as the y-axis. In a three-dimensional coordinate system, another axis, normally referred to as the z-axis (not shown), is added, providing a third dimension of space measurement. The movement of a user's finger in the z-axis is measured when the user applies a force to push the gimbaled button. The axes may be defined as mutually orthogonal to each other (each at a right angle to the other).

The point of intersection, where the axes meet, is called the origin 306. The x and y axes define a plane that is referred to as the x-y plane. To specify a particular point on a two-dimensional coordinate system, indicate the x unit first (abscissa), followed by the y unit (ordinate) in the form (x, y), an ordered pair. For example, point 308 may be represented by the ordered pair (x₁, y₁), which indicates its horizontal (x₁) and vertical (y₁) distances from the origin 306. From the X-Y grid, the radius and angular information of the polar coordinate system may be derived. For example, for the ordered pair (x₁, y₁), its radial distance from the origin equals the square root of (x₁²+y₁²), and its angular position (θ) from the 0° polar axis equals to tan⁻¹(y₁/x₁). With the computed radius and angular information, the techniques described for the polar coordinate system in FIGS. 2A-2D are also applicable to the X-Y grid shown in FIG. 3B.

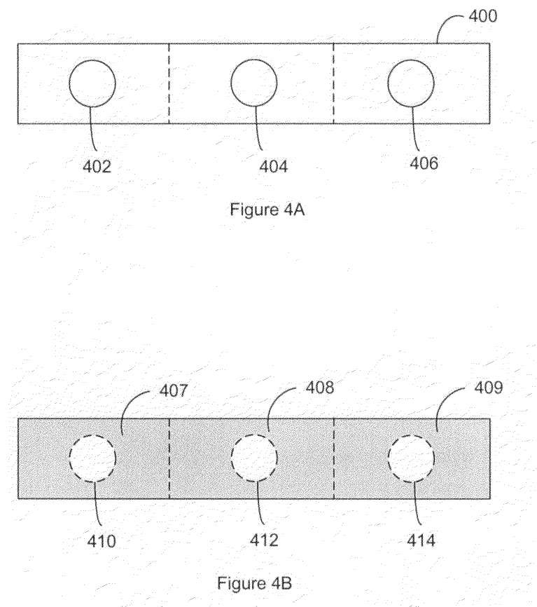

FIGS. 4A and 4B illustrate a method for implementing a group of buttons according to some embodiments of the present disclosure. FIG. 4A shows conventional device 400 consisting of three buttons 402, 404, and 406, where each button is implemented by a mechanical switch (not shown). FIG. 4B shows an implementation of the three buttons of FIG. 4A using a group of sensors and only one switch (e.g. a gimbaled button). In the example shown in FIG. 4B, the device may be configured into sensor regions 407, 408, and 409 for sensing user inputs corresponding to pseudo buttons 410, 412, and 414 (shown as dotted line), respectively. In this approach, one switch, for example implemented by a gimbaled button, may be located in the position of middle button 412. Using similar principles to those described for FIGS. 2A-2D, the combination of the three sensor regions and the gimbaled button may be capable of simulating the functionalities of three separate mechanical switches as shown in FIG. 4A.

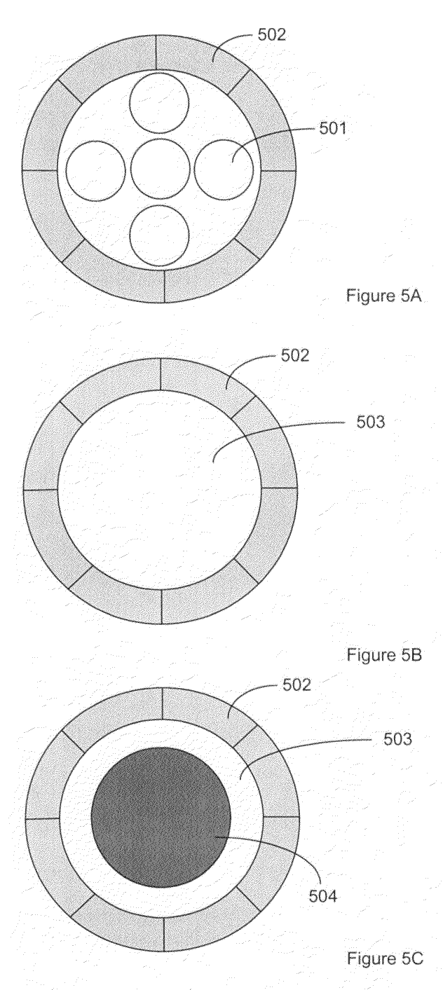

FIGS. 5A-5C illustrate sensor configurations for implementing multiple buttons in an input device according to some embodiments of the present disclosure. The example in FIG. 5A shows a top view of input device containing five switches 501 that implement five push buttons with touch sensors 502 placed outside the area containing switches 501. This sensor configuration solves the crowdedness problem of the conventional click wheel of FIG. 1C. In this arrangement, there is more room around the switches for routing the signals generated because the sensors are no longer placed in the same area with the switches. Similarly, there is more room underneath the touch sensors for routing the signals generated by the touch sensors because the switches are no longer placed in the same area with the sensors. In this sensor configuration, the set of sensors can detect the angular position of a user's finger (or stylus) and thus can provide the scrolling functionalities of the click wheel. In addition, the sensors may be used to detect positional information (e.g. radial distance) for determining whether the user has pressed the center button or the top, bottom, left, or right button.

In the case when the click wheel is relatively small, for example less than about 20 millimeters, the entire click wheel may be covered by the user's finger, which may make it challenging to detect the circular scrolling motion of the user's finger. By placing the touch sensors outside the cutout area, this sensor configuration can give the user more room to scroll and thus can improve the user experience of the input device.

FIG. 5B shows a top view of a click wheel device implemented with a gimbaled button with touch sensors 502 placed outside the area containing the mechanical switches. Similar to FIG. 5A, this sensor configuration can solve the crowdedness problem of the conventional click wheel of FIG. 1C. In this arrangement, the combination of gimbaled button 503 and the touch sensors 502 can implement the functionalities of multiple mechanical switches as described previously in association with FIGS. 2A-2D, 3A, and 3B. In the example shown in FIG. 5C, it adds an optional additional set of sensors 504 to improve the accuracy of position and angular information detected by sensors 502.

FIGS. 6A-6C illustrate implementations of a gimbaled button in an input device according to some embodiments of the present disclosure. Input device 600 can include touch pad 604 mounted on gimbaled plate 605. The gimbaled plate can be held within space 601 in a housing with top plate 602. Gimbaled plate 604 can lie on top of flexible member 608.

One or more movement detectors can be activated by the movement of gimbaled plate 605. For example, one or more movement detectors can be positioned around or on gimbaled plate 605 and can be activated by the tilt or other desired movement of gimbaled plate 605. Flexible member 608 can be part of the movement detector, for example a surface-mount dome switch.

Flexible member 608 can be formed in a bubble shape that can provide the spring force to push the gimbaled plate into mating engagement with the top wall of frame 602 and away from supportive surface of flexible member 608. Tab 606 can protrude from the side of gimbaled plate 606 and extend under top plate 602.

Gimbaled plate 605 can be allowed to float within cutout 601. The shape of cutout 601 generally can coincide with the shape of gimbaled plate 604. As such, the unit can be substantially restrained along the x and y axes via side wall 603 of top plate 602 and along the z axis via engagement of top plate 602 and tab 606 on gimbaled plate 604. Gimbaled plate 604 may thus be able to move within space 601 while still being prevented from moving entirely out of the space 601 via the walls of the top plate 602.

With respect to FIGS. 6B and 6C, according to one embodiment, a user presses on gimbaled plate 604 in the location of the desired button function. As shown in FIG. 6B, if the user presses on side of gimbaled plate 604 with a force that exceeds a first activation threshold of flexible member 608, the gimbaled plate tilts and thus causes flexible member 608 to deform asymmetrically. Tab 606 and supportive surface 610 can limit the amount of tilt of the gimbaled plate. The gimbaled plate may be tilted about an axis in a 360 degree pattern around the gimbaled plate. One or more movement detectors can be positioned to monitor the movement of the gimbaled plate.

FIG. 6C shows that if the user presses down on the center of gimbaled plate 604 with a force that exceeds a second activation threshold of flexible member 608, the gimbaled plate moves down into the housing without tilting and thus causes flexible member 608 to deform symmetrically. The gimbaled plate is nonetheless still restrained within the housing by the walls of top plate 602. Note that the second activation threshold may be the same or different as the first activation threshold of the flexible member.

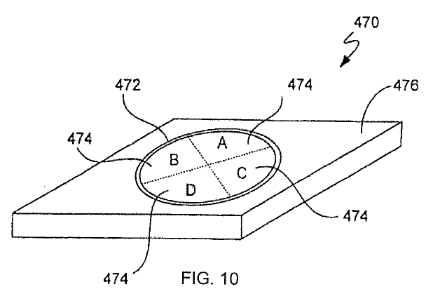

Touch pad 605, mounted on gimbaled plate 604, provides the position of the user's finger when gimbaled plate 604 is pressed. This positional information is used by the input device to determine what button function is desired by the user. For example, the interface may be divided into distinct button zones as shown in FIG. 10. In this instance, activation of a single movement detector that monitors the movement of gimbaled plate 605 can be used to provide several button commands. For example, a first signal generated by touch pad 604 on gimbaled plate 605 may generate a first signal that indicates the position of the user's finger on the gimbaled plate. A movement detector such as a dome switch can then be used to generate a second signal that indicates that the gimbaled plate has been moved, for example, depressed.

The input device including the gimbaled plate and a touch pad can be part of computer system 439 as shown in FIG. 9. Communication interface 454 can provide the first and second signals provided by the touch pad and the movement detector respectively to computing device 442 including processor 456. The processor can then determine which command is associated with the combination of the first and second signals. In this manner, activating the movement detector by pressing on the touch pad in different positions can correspond to different actions and a single movement detector can be used to provide the functionality of multiple buttons positioned around the gimbaled plate 605.

One of the benefits of using a touch pad 605 and gimbaled plate 604 as configured in FIGS. 6A-6C is that multiple button functions can be emulated with a single movement detector. This can be used to produce a device with fewer parts as compared to devices that use a different movement detector to produce each button command.

Having a single movement detector positioned under the gimbaled plate can also improve the tactile feel of the input device. A user of the device will feel only a single click on any part of the gimbaled plate the user presses. Having multiple mechanical switch type movement detectors under a gimbaled plate can result in a “crunching” type feel in which the user feels multiple clicks in series when they press down on the gimbaled plate.

FIGS. 7A-7C illustrate other implementations of an input device according to some embodiments of the present disclosure. In the examples shown in FIGS. 7A-7C, first dome switch 622 may be activated by a user pressing anywhere around click wheel 624, and second dome switch 626 may be activated by depressing center button 628.

FIG. 7A-7C shows a cross section of click wheel 624 that surrounds center button 628, which is positioned in the center of the click wheel. Click wheel 624 includes a touch pad 625. Click wheel 624 is configured to gimbal relative to frame 630 in order to provide a clicking action for any position on click wheel 624.

Click wheel 624 is restrained within space 632 provided in frame 630. Click wheel 624 is capable of moving within space 632 while still being prevented from moving entirely out of space 632 via the walls of frame 630. The shape of space 632 generally coincides with the shape of click wheel 624. As such, the unit is substantially restrained along the x and y axes via side wall 634 of frame 630 and along the z axis via top wall 636 and bottom wall 640 of frame 630. A small gap may be provided between the side walls and the platform to allow the touch pad to gimbal 360 degrees around its axis without obstruction (e.g., a slight amount of play). In some cases, the platform may include tabs that extend along the x and y axes so as to prevent rotation about the z axis.

Center button 628 can be positioned within space 642 in click wheel 624. Center button 628 may be constrained within space 642 along the x and y axes via side wall 644 of click wheel 624 and along the z axis by tabs 646 of click wheel 624 and by bottom wall 640, which connects with legs 647 when center button 628 is pressed. 10058] Positioned beneath center button 628 are two dome switches 622 and 626. The two dome switches provide the mechanical spring action center button 628 and click wheel 624. Stiffener 648 is positioned between the two dome switches. Stiffener 648 extends through holes in legs 647 and under click wheel 624. In this manner, stiffener 648 can transmit the spring force of dome switches 622 and 626 to click wheel 624 and can transmit a force applied by a user to click wheel 624 to dome switch 622.

FIG. 7B shows how only click wheel dome switch 622 is activated when a user depresses click wheel 624. When a user depresses anywhere on click wheel 624, it gimbals in area 632 and the force applied by the user is conveyed to inverted dome switch 622 by stiffener 648 and bottom wall 640. Bottom wall 640 may include nub 650 for conveying the force of the click to the center of dome switch 622. Center button dome switch 626 does not actuate since it pivots together with click wheel 624. The clearance between center button 628 and the snap dome below it remains substantially the same as it pivots together with the click wheel.

FIG. 7C shows how only the center dome switch is activated when center button 628 is depressed. Feet 647 can prevent center button 628 from exceeding the travel of upper dome 626. To ensure that only upper dome 626 is actuated, the actuation force of the lower dome 622 may be higher than the actuation force of upper dome 626. Center button 628 may include nub 652 for conveying the force of the click to the center of upper dome 626.

As with the configuration described with respect to FIGS. 6A-6C, signals from touch pad 625 that forms part of click wheel 624 can be used in combination with the signal from the activation of dome switch 622 to simulate several buttons mounted in different areas around click wheel 624. This configuration can allow for a separate center button to be used. This can be particularly useful when a touch pad that can only sense angular position is used in click wheel 624. When only angular position is measured, a center button can not be simulated since the position of the user's finger relative to the center of the click wheel may not be measured.

Although not shown, the touch pad may be back lit in some cases. For example, the circuit board can be populated with light emitting diodes (LEDs) on either side in order to designate button zones, provide additional feedback and the like.

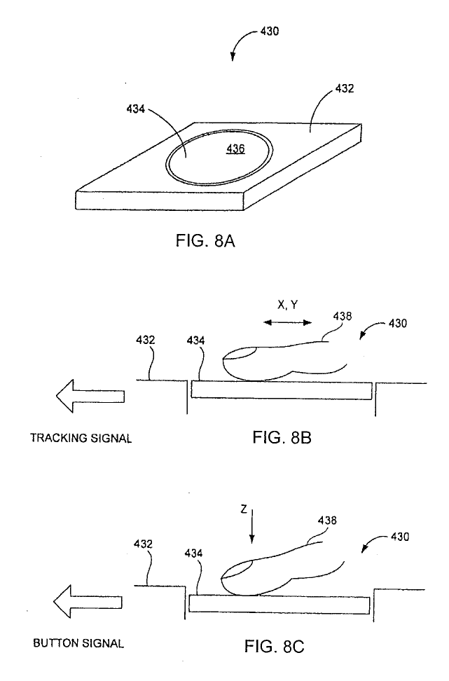

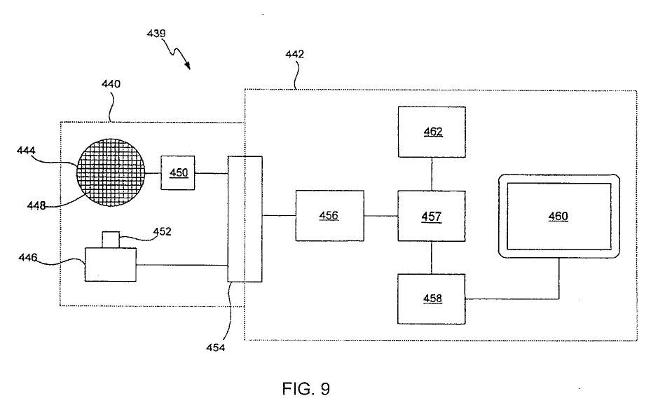

FIGS. 8A-8C illustrate operations of an input device according to some embodiments of the present disclosure. In the example shown in FIG. 8A, input device 430 may generally be configured to send information or data to an electronic device in order to perform an action on a display screen (e.g., via a graphical user interface). Examples of actions that may be performed include, moving an input pointer, making a selection, providing instructions, etc. The input device may interact with the electronic device through a wired connection (e.g., cable/connector) or a wireless connection (e.g., IR, Bluetooth, etc.). Input device 430 may be a stand alone unit or it may be integrated into the electronic device. As a stand alone unit, the input device may have its own enclosure. When integrated into an electronic device, the input device can typically use the enclosure of the electronic device. In either case, the input device may be structurally coupled to the enclosure, as for example, through screws, snaps, retainers, adhesives and the like. In some cases, the input device may be removably coupled to the electronic device, as for example, through a docking station. The electronic device to which the input device is coupled may correspond to any consumer related electronic product. By way of example, the electronic device may correspond to a computer such as desktop computer, laptop computer or PDA, a media player such as a music player, a communication device such as a cellular phone, another input device such as a keyboard, and the like.

As shown in FIG. 8A, in this embodiment input device 430 may include frame 432 (or support structure) and touch pad 434. Frame 432 can provide a structure for supporting the components of the input device. Frame 432 in the form of a housing may also enclose or contain the components of the input device. The components, which include touch pad 434, may correspond to electrical, optical and/or mechanical components for operating input device 430.

Touch pad 434 can provide location information for an object in contact with or in proximity to the touch pad. This information can be used in combination with information provided by a movement indicator to generate a single command associated with the movement of the touch pad. The touch pad can be used as an input device by itself, for example, the touch pad may be used to move an object or scroll through a list of items on the device.

Touch pad 434 may be widely varied. For example, it may be a conventional touch pad based on the Cartesian coordinate system, or it may be a touch pad based on a Polar coordinate system. An example of a touch pad based on polar coordinates may be found in U.S. Pat. No. 7,046,230, entitled “TOUCH PAD FOR HANDHELD DEVICE,” which is herein incorporated by reference. Furthermore, touch pad 434 may be used in at least two different modes, which may be referred to as a relative mode and/or an absolute mode. In absolute mode, touch pad 434 can, for example, report the absolute coordinates of the location at which it is being touched. For example, these would be “x” and “y” coordinates in the case of a standard Cartesian coordinate system or (r,θ) in the case of a Polar coordinate system. In relative mode, touch pad 434 can report the direction and/or distance of change, for example, left/right, up/down, and the like. In most cases, the signals produced by touch pad 434 can direct movement on the display screen in a direction similar to the direction of the finger as it is moved across the surface of touch pad 434.

The shape of touch pad 434 may be widely varied. For example, it may be circular, oval, square, rectangular, triangular, and the like. In general, the outer perimeter can define the working boundary of touch pad 434. In the illustrated embodiment, the touch pad is circular. Circular touch pads can allow a user to continuously swirl a finger in a free manner, i.e., the finger can be rotated through 360 degrees of rotation without stopping. This form of motion may produce incremental or accelerated scrolling through a list of songs being displayed on a display screen, for example. Furthermore, the user can rotate his or her finger tangentially from all sides, thus providing more finger position range. Both of these features may help when performing a scrolling function. Furthermore, the size of touch pad 434 generally corresponds to a size that can allow it to be easily manipulated by a user (e.g., the size of a finger tip or larger).

Touch pad 434, which can generally take the form of a rigid planar platform, includes touchable outer surface 436 for receiving a finger (or object) for manipulation of the touch pad. Although not shown in FIG. 8A, beneath touchable outer surface 436 is a sensor arrangement that may be sensitive to such things as the pressure and movement of a finger thereon. The sensor arrangement can typically include a plurality of sensors that may be configured to activate as the finger sits on, taps on or passes over them. In the simplest case, an electrical signal may be produced each time the finger is positioned over a sensor. The number of signals in a given time frame may indicate location, direction, speed and acceleration of the finger on touch pad 434, i.e., the more signals, the more the user moved his or her finger. In most cases, the signals may be monitored by an electronic interface that converts the number, combination and frequency of the signals into location, direction, speed and acceleration information. This information may then be used by the electronic device to perform the desired control function on the display screen. The sensor arrangement may be widely varied. By way of example, the sensors may be based on resistive sensing, surface acoustic wave sensing, pressure sensing (e.g., strain gauge), optical sensing, capacitive sensing and the like.

In the illustrated embodiment, touch pad 434 may be based on capacitive sensing. A capacitively based touch pad may be arranged to detect changes in capacitance as the user moves an object such as a finger around the touch pad. In most cases, the capacitive touch pad can include a protective shield, one or more electrode layers, a circuit board and associated electronics including an application specific integrated circuit (ASIC). The protective shield may be placed over the electrodes; the electrodes may be mounted on the top surface of the circuit board; and the ASIC may be mounted on the bottom surface of the circuit board. The protective shield can serve to protect the underlayers and to provide a surface for allowing a finger to slide thereon. The surface may generally be smooth so that the finger does not stick to it when moved. The protective shield also can provide an insulating layer between the finger and the electrode layers. The electrode layer can include a plurality of spatially distinct electrodes. Any suitable number of electrodes may be used. As the number of electrodes increases, the resolution of the touch pad also increases.

Capacitive sensing can work according to the principles of capacitance. As should be appreciated, whenever two electrically conductive members come close to one another without actually touching, their electric fields can interact to form capacitance. In the configuration discussed above, the first electrically conductive member may be one or more of the electrodes and the second electrically conductive member may be the finger of the user. Accordingly, as the finger approaches the touch pad, a tiny capacitance can form between the finger and the electrodes in close proximity to the finger. The capacitance in each of the electrodes may be measured by the ASIC located on the backside of the circuit board. By detecting changes in capacitance at each of the electrodes, the ASIC can determine the location, direction, speed and acceleration of the finger as it is moved across the touch pad. The ASIC can also report this information in a form that can be used by the electronic device.

In accordance with one embodiment, touch pad 434 may be movable relative to the frame 432. This movement may be detected by a movement detector that generates another control signal. By way of example, touch pad 434 in the form of the rigid planar platform may rotate, pivot, slide, translate, flex and/or the like relative to frame 432. Touch pad 434 may be coupled to frame 432 and/or it may be movably restrained by frame 432. By way of example, touch pad 434 may be coupled to frame 432 through axels, pin joints, slider joints, ball and socket joints, flexure joints, magnets, cushions and/or the like. Touch pad 434 may also float within a space of the frame (e.g., gimbal). It should be noted that input device 430 may additionally include a combination of joints such as a pivot/translating joint, pivot/flexure joint, pivot/ball and socket joint, translating/flexure joint, and the like to increase the range of movement (e.g., increase the degree of freedom).

When moved, touch pad 434 may be configured to actuate a movement detector circuit that generates one or more signals. The circuit can generally include one or more movement detectors such as switches, sensors, encoders, and the like.

In the illustrated embodiment, touch pad 434 may be part of a depressible platform. The touch pad operates as a button and performs one or more mechanical clicking actions. Multiple functions of the device can be accessed by depressing the touch pad 434 in different locations. A movement detector signals that touch pad 434 has been depressed, and touch pad 434 signals a location on the platform that has been touched. By combining both the movement detector signals and touch pad signals, touch pad 434 acts like multiple buttons such that depressing the touch pad at different locations corresponds to different buttons. As shown in FIGS. 8B and 8C, according to one embodiment touch pad 434 is capable of moving between an upright position (FIG. 8B) and a depressed position (FIG. 8C) when a substantial force from finger 438, palm, hand or other object may be applied to touch pad 434. Touch pad 434 is typically spring biased in the upright position, as for example through a spring member. Touch pad 434 moves to the depressed position when the spring bias may be overcome by an object pressing on touch pad 434.

As shown in FIG. 8B, touch pad 434 generates tracking signals when an object such as a user's finger is moved over the top surface of the touch pad in the x, y plane. As shown in FIG. 8C, in the depressed position (z direction), touch pad 434 generates both positional information and a movement indicator generates a signal indicating that touch pad 434 has moved. The positional information and the movement indication are combined to form a button command. Different button commands can correspond to depressing touch pad 434 in different locations. The different button commands may be used for various functionalities including, but not limited to, making selections or issuing commands associated with operating an electronic device. By way of example, in the case of a music player, the button commands may be associated with opening a menu, playing a song, fast forwarding a song, seeking through a menu and the like.

To elaborate, touch pad 434 may be configured to actuate a movement detector, which together with the touch pad positional information, can form a button command when touch pad 434 is moved to the depressed position. The movement detector may typically be located within frame 432 and may be coupled to touch pad 434 and/or frame 432. The movement detector may be any combination of switches and sensors. Switches are generally configured to provide pulsed or binary data such as activate (on) or deactivate (off). By way of example, an underside portion of touch pad 434 may be configured to contact or engage (and thus activate) a switch when the user presses on touch pad 434. The sensors, on the other hand, are generally configured to provide continuous or analog data. By way of example, the sensor may be configured to measure the position or the amount of tilt of touch pad 434 relative to the frame when a user presses on the touch pad 434. Any suitable mechanical, electrical and/or optical switch or sensor may be used. For example, tact switches, force sensitive resistors, pressure sensors, proximity sensors, and the like may be used. In some case, the spring bias for placing touch pad 434 in the upright position may be provided by a movement detector that includes a spring action.

FIG. 9 illustrates an example of a simplified block diagram of a computing system 439. The computing system can generally include input device 440 operatively connected to computing device 442. By way of example, input device 440 may generally correspond to input device 430 shown in FIGS. 1, 2A and 2B, and the computing device 442 may correspond to a computer, PDA, media player or the like. As shown, input device 440 includes depressible touch pad 444 and one or more movement detectors 446. Touch pad 444 may be configured to generate tracking signals and movement detector 446 is configured to generate a movement signal when the touch pad is depressed. Although touch pad 444 may be widely varied, in this embodiment, touch pad 444 can include capacitance sensors 448 and control system 450 for acquiring position signals from sensors 448 and supplying the signals to computing device 442. Control system 450 may include an application specific integrated circuit (ASIC) that may be configured to monitor the signals from sensors 448, to compute the angular location, direction, speed and acceleration of the monitored signals and to report this information to a processor of computing device 442. Movement detector 446 may also be widely varied. In this embodiment, however, movement detector 446 can take the form of a switch that generates a movement signal when touch pad 444 is depressed. The switch 446 may correspond to a mechanical, electrical or optical style switch. In one particular implementation, switch 446 is a mechanical style switch that includes protruding actuator 452 that may be pushed by touch pad 444 to generate the movement signal. By way of example, the switch may be a tact or dome switch.

Both touch pad 444 and switch 446 are operatively coupled to computing device 442 through communication interface 454. The communication interface provides a connection point for direct or indirect connection between the input device and the electronic device. Communication interface 454 may be wired (wires, cables, connectors) or wireless (e.g., transmitter/receiver).

Referring to computing device 442, it generally includes processor 457 (e.g., CPU or microprocessor) configured to execute instructions and to carry out operations associated with computing device 442. For example, using instructions retrieved from memory, the processor may control the reception and manipulation of input and output data between components of computing device 442. Processor 457 may be configured to receive input from both switch 446 and touch pad 444 and can form a signal/command that may be dependent upon both of these inputs. In most cases, processor 457 can execute instruction under the control of an operating system or other software. Processor 457 can be a single-chip processor or can be implemented with multiple components.

Computing device 442 also includes input/output (I/O) controller 456 that may be operatively coupled to processor 457. (I/O) controller 456 may be integrated with processor 457 or it may be a separate component as shown. I/O controller 456 can generally be configured to control interactions with one or more I/O devices that can be coupled to the computing device 442, as for example input device 440. I/O controller 456 can generally operate by exchanging data between computing device 442 and I/O devices that desire to communicate with computing device 442.

Computing device 442 also includes display controller 458 that may be operatively coupled to processor 457. Display controller 458 may be integrated with processor 457 or it may be a separate component as shown. Display controller 458 may be configured to process display commands to produce text and graphics on display screen 460. By way of example, display screen 460 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like. In the illustrated embodiment, the display device corresponds to a liquid crystal display (LCD).

In most cases, processor 457 together with an operating system operates to execute computer code and produce and use data. The computer code and data may reside within program storage area 462 that may be operatively coupled to processor 457. Program storage area 462 can generally provide a place to hold data that is being used by computing device 442. By way of example, the program storage area may include Read-Only Memory (ROM), Random-Access Memory (RAM), hard disk drive and/or the like. The computer code and data could also reside on a removable program medium and loaded or installed onto the computing device when needed. In one embodiment, program storage area 462 may be configured to store information for controlling how the tracking and movement signals generated by the input device are used in combination by computing device 442 to generate a single button command.

FIG. 10 illustrates a simplified perspective diagram of input device 470. Like the input device shown in the embodiment of FIG. 8B and 8C, this input device 470 incorporates the functionality of one or more buttons directly into touch pad 472, i.e., the touch pad acts like a button. In this embodiment, however, touch pad 472 may be divided into a plurality of independent and spatially distinct button zones 474. Button zones 474 can represent regions of the touch pad 472 that may be moved by a user to implement distinct button functions. The dotted lines can represent areas of touch pad 472 that make up an individual button zone. Any number of button zones may be used, for example, two or more, four, eight, etc. In the illustrated embodiment, touch pad 472 includes four button zones 474 (i.e., zones A-D).

As should be appreciated, the button functions generated by pressing on each button zone may include selecting an item on the screen, opening a file or document, executing instructions, starting a program, viewing a menu, and/or the like. The button functions may also include functions that make it easier to navigate through the electronic system, as for example, zoom, scroll, open different menus, home the input pointer, perform keyboard related actions such as enter, delete, insert, page up/down, and the like. In the case of a music player, one of the button zones may be used to access a menu on the display screen, a second button zone may be used to seek forward through a list of songs or fast forward through a currently playing song, a third button zone may be used to seek backwards through a list of songs or fast rearward through a currently playing song, and a fourth button zone may be used to pause or stop a song that is being played.

To elaborate, touch pad 472 is capable of moving relative to frame 476 so as to create a clicking action. Frame 476 may be formed from a single component or it may be a combination of assembled components. The clicking action can actuate a movement detector contained inside frame 476. The movement detector may be configured to sense movements of the button zones during the clicking action and to send a signal corresponding to the movement to the electronic device. By way of example, the movement detectors may be switches, sensors and/or the like.

In addition, touch pad 472 may be configured to send positional information on what button zone is being acted on when the clicking action occurs. The positional information can allow the device to determine which button zone is being activated when the touch pad is moved relative to the frame.

The movements of each of button zones 474 may be provided by various rotations, pivots, translations, flexes and the like. In one embodiment, touch pad 472 may be configured to gimbal relative to frame 476. By gimbal, it is generally meant that the touch pad 472 is able to float in space relative to frame 476 while still being constrained thereto. The gimbal may allow the touch pad 472 to move in single or multiple degrees of freedom (DOF) relative to the housing, for example, movements in the x, y and/or z directions and/or rotations about the x, y, and/or z axes (θₓθ_{y}θ_{z}).

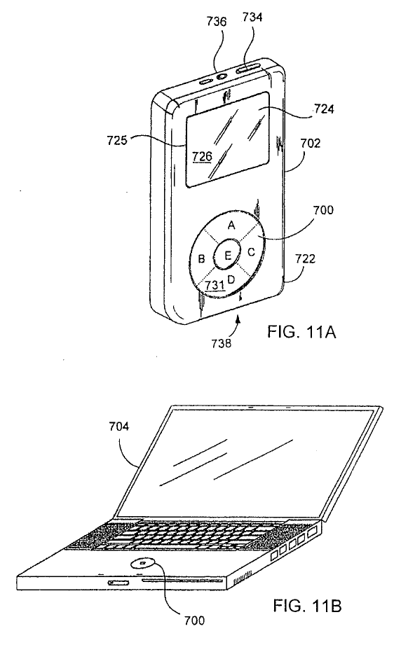

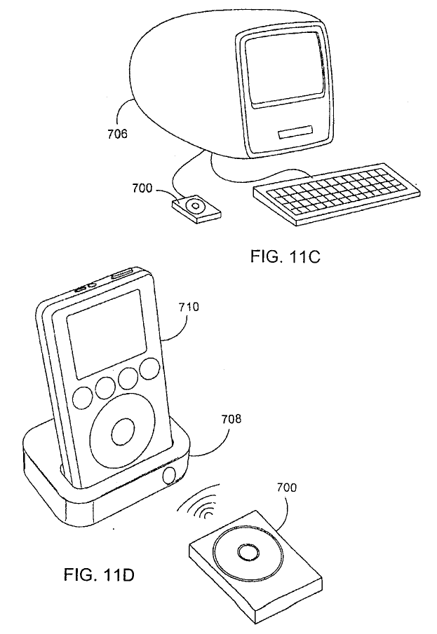

FIGS. 11A-11D illustrate applications of the click wheel device according to some embodiments of the present disclosure. As previously mentioned, the input devices described herein may be integrated into an electronic device or they may be separate stand alone devices. FIGS. 7 and 8 show some implementations of input device 700 integrated into an electronic device. In FIG. 11A, input device 700 may be incorporated into media player 702. In FIG. 11B, input device 700 is incorporated into laptop computer 704. FIGS. 11C and 11D, on the other hand, show some implementations of input device 700 as a stand alone unit. In FIG. 11C, input device 700 is a peripheral device that is connected to desktop computer 706. In FIG. 11D, input device 700 may be a remote control that wirelessly connects to docking station 708 with media player 710 docked therein. It should be noted, however, that the remote control can also be configured to interact with the media player (or other electronic device) directly thereby eliminating the need for a docking station. An example of a docking station for a media player can be found in U.S. patent application Ser. No. 10/423,490, entitled “MEDIA PLAYER SYSTEM,” filed Apr. 25, 2003, which is hereby incorporated by reference. It should be noted that these particular embodiments are not a limitation and that many other devices and configurations may be used.

Referring back to FIG. 11A, media player 702 is discussed in greater detail. The term “media player” generally refers to computing devices that may be dedicated to processing media such as audio, video or other images, as for example, music players, game players, video players, video recorders, cameras, and the like. In some cases, the media players contain single functionality (e.g., a media player dedicated to playing music) and in other cases the media players contain multiple functionality (e.g., a media player that plays music, displays video, stores pictures and the like). In either case, these devices can generally be portable so as to allow a user to listen to music, play games or video, record video or take pictures wherever the user travels.

In one embodiment, the media player can be a handheld device that is sized for placement into a pocket of the user. By being pocket sized, the user does not have to directly carry the device and therefore the device can be taken almost anywhere the user travels (e.g., the user is not limited by carrying a large, bulky and often heavy device, as in a laptop or notebook computer). For example, in the case of a music player, a user may use the device while working out at the gym. In case of a camera, a user may use the device while mountain climbing. In the case of a game player, the user may use the device while traveling in a car. Furthermore, the device may be operated by the user's hands. No reference surface, such as a desktop, is needed. In the illustrated embodiment, the media player 702 may be a pocket sized hand held MP3 music player that allows a user to store a large collection of music (e.g., in some cases up to 4,000 CD-quality songs). By way of example, the MP3 music player may correspond to the iPod® brand MP3 player manufactured by Apple Computer, Inc. of Cupertino, Calif. Although used primarily for storing and playing music, the MP3 music player shown herein may also include additional functionality such as storing a calendar and phone lists, storing and playing games, storing photos and the like. In fact, in some cases, it may act as a highly transportable storage device.

As shown in FIG. 11A, media player 702 includes housing 722 that encloses various electrical components (including integrated circuit chips and other circuitry) internally to provide computing operations for media player 702. In addition, the housing 722 may also define the shape or form of media player 702. That is, the contour of housing 722 may embody the outward physical appearance of media player 702. The integrated circuit chips and other circuitry contained within housing 722 may include a microprocessor (e.g., CPU), memory (e.g., ROM, RAM), a power supply (e.g., battery), a circuit board, a hard drive, other memory (e.g., flash) and/or various input/output (I/O) support circuitry. The electrical components may also include components for inputting or outputting music or sound such as a microphone, amplifier and a digital signal processor (DSP). The electrical components may also include components for capturing images such as image sensors (e.g., charge coupled device (CCD) or complimentary metal-oxide semiconductor (CMOS)) or optics (e.g., lenses, splitters, filters).

In the illustrated embodiment, media player 702 can, for example, include a hard drive thereby giving the media player massive storage capacity. For example, 20 GB hard drive can store up to 4000 songs or about 266 hours of music. In contrast, flash-based media players on average can store up to 2 GB, or about two hours, of music. The hard drive capacity may be widely varied (e.g., 10, 20 GB, etc.). In addition to the hard drive, media player 702 shown herein also can include a battery such as a rechargeable lithium polymer battery. These types of batteries are capable of offering about 10 hours of continuous playtime to the media player.

Media player 702 also can include display screen 724 and related circuitry. The display screen 724 may be used to display a graphical user interface as well as other information to the user (e.g., text, objects, graphics). By way of example, display screen 724 may be a liquid crystal display (LCD). In one particular embodiment, the display screen can correspond to a 160-by-128-pixel high-resolution display, with a white LED backlight to give clear visibility in daylight as well as low-light conditions. As shown, display screen 724 may be visible to a user of media player 702 through opening 725 in housing 722 and through transparent wall 726 that may be disposed in front of opening 725. Although transparent, transparent wall 726 may be considered part of housing 722 since it helps to define the shape or form of media player 702.

Media player 702 can also include touch pad 700 such as any of those previously described. Touch pad 700 can generally consist of touchable outer surface 731 for receiving a finger for manipulation on touch pad 730. Although not shown in FIG. 11A, beneath touchable outer surface 731 is a sensor arrangement. The sensor arrangement can include a plurality of sensors that may be configured to activate as the finger sits on, taps on or passes over them. In the simplest case, an electrical signal is produced each time the finger is positioned over a sensor. The number of signals in a given time frame may indicate location, direction, speed and acceleration of the finger on the touch pad, i.e., the more signals, the more the user moved his or her finger. In most cases, the signals are monitored by an electronic interface that converts the number, combination and frequency of the signals into location, direction, speed and acceleration information. This information may then be used by media player 702 to perform the desired control function on display screen 724. For example, a user may easily scroll through a list of songs by swirling the finger around touch pad 700.

In addition to above, the touch pad may also include one or more movable buttons zones A-D as well as a center button E. The button zones are configured to provide one or more dedicated control functions for making selections or issuing commands associated with operating media player 702. By way of example, in the case of an MP3 music player, the button functions may be associated with opening a menu, playing a song, fast forwarding a song, seeking through a menu, making selections and the like. In most cases, the button functions are implemented via a mechanical clicking action.

The position of touch pad 700 relative to housing 722 may be widely varied. For example, touch pad 700 may be placed at any external surface (e.g., top, side, front, or back) of housing 722 that is accessible to a user during manipulation of media player 702. In most cases, touch sensitive surface 731 of touch pad 700 is completely exposed to the user. In the embodiment illustrated in FIG. 11A, touch pad 700 is located in a lower front area of housing 722. Furthermore, touch pad 700 may be recessed below, level with, or extend above the surface of housing 722. In the embodiment illustrated in FIG. 11A, touch sensitive surface 731 of touch pad 700 may be substantially flush with the external surface of housing 722.

The shape of touch pad 700 may also be widely varied. Although shown as circular, the touch pad may also be square, rectangular, triangular, and the like. More particularly, the touch pad is annular, i.e., shaped like or forming a ring. As such, the inner and outer perimeter of the touch pad defines the working boundary of the touch pad.

Media player 702 may also include hold switch 734. Hold switch 734 may be configured to activate or deactivate the touch pad and/or buttons associated therewith. This is generally done to prevent unwanted commands by the touch pad and/or buttons, as for example, when the media player is stored inside a user's pocket. When deactivated, signals from the buttons and/or touch pad may not be sent or disregarded by the media player. When activated, signals from the buttons and/or touch pad may be sent and therefore received and processed by the media player.

Moreover, media player 702 may also include one or more headphone jacks 736 and one or more data ports 738. Headphone jack 736 is capable of receiving a headphone connector associated with headphones configured for listening to sound being outputted by media device 702. Data port 738, on the other hand, is capable of receiving a data connector/cable assembly configured for transmitting and receiving data to and from a host device such as a general purpose computer (e.g., desktop computer, portable computer). By way of example, data port 738 may be used to upload or download audio, video and other images to and from media device 702. For example, the data port may be used to download songs and play lists, audio books, ebooks, photos, and the like into the storage mechanism of the media player.

Data port 738 may be widely varied. For example, the data port may be a PS/2 port, a serial port, a parallel port, a USB port, a Firewire port and/or the like. In some cases, data port 738 may be a radio frequency (RF) link or optical infrared (IR) link to eliminate the need for a cable. Although not shown in FIG. 11A, media player 702 may also include a power port that receives a power connector/cable assembly configured for delivering power to media player 702. In some cases, data port 738 may serve as both a data and power port. In the illustrated embodiment, data port 738 is a Firewire port having both data and power capabilities.

Although only one data port is shown, it should be noted that this is not a limitation and that multiple data ports may be incorporated into the media player. In a similar vein, the data port may include multiple data functionality, i.e., integrating the functionality of multiple data ports into a single data port. Furthermore, it should be noted that the position of the hold switch, headphone jack and data port on the housing may be widely varied. That is, they are not limited to the positions shown in FIG. 11 A. They may be positioned almost anywhere on the housing (e.g., front, back, sides, top, bottom). For example, the data port may be positioned on the top surface of the housing rather than the bottom surface as shown.

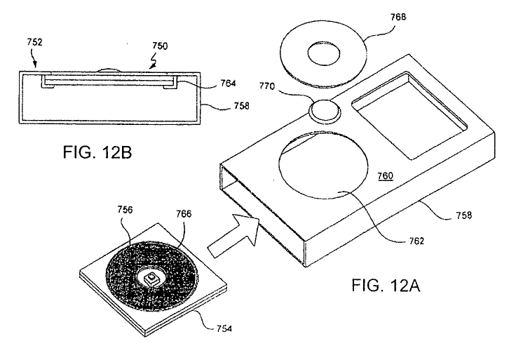

FIGS. 12A and 12B illustrate installation of an input device into a media player according to some embodiments of the present disclosure. By way of example, input device 750 may correspond to any of those previously described and media player 752 may correspond to the one shown in FIG. 11A. As shown, input device 750 can include housing 754 and touch pad assembly 756. Media player 752 can include shell or enclosure 758. Front wall 760 of shell 758 can include opening 762 for allowing access to touch pad assembly 756 when input device 750 is introduced into media player 752. The inner side of front wall 760 can include channel or track 764 for receiving input device 750 inside shell 758 of media player 752. Channel 764 may be configured to receive the edges of housing 754 of input device 750 so that input device 750 can be slid into its desired place within shell 758. The shape of the channel has a shape that generally coincides with the shape of housing 754. During assembly, circuit board 766 of touch pad assembly 756 is aligned with opening 762 and cosmetic disc 768 and button cap 770 are mounted onto the top side of circuit board 766. As shown, cosmetic disc 768 has a shape that may generally coincide with opening 762. The input device may be held within the channel via a retaining mechanism such as screws, snaps, adhesives, press fit mechanisms, crush ribs and the like.

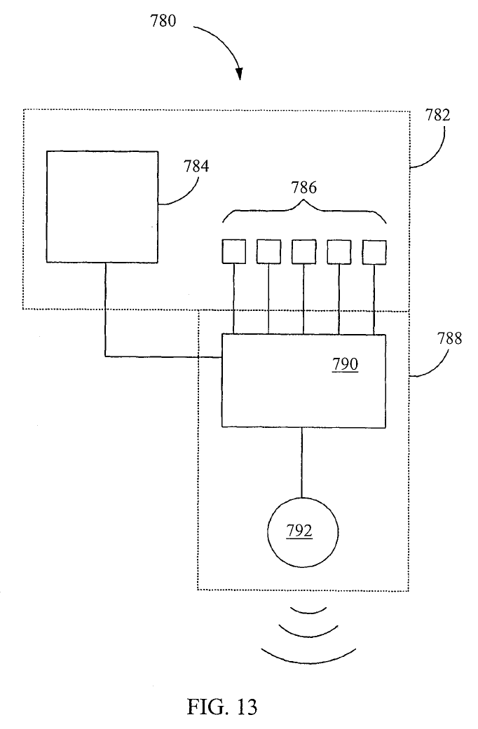

FIG. 13 illustrates a simplified block diagram of a remote control incorporating an input device according to some embodiments of the present disclosure. By way of example, input device 782 may correspond to any of the previously described input devices. In this particular embodiment, input device 782 can correspond to the input device shown in FIGS. 6A-6C and 7A-7C, thus the input device includes touch pad 784 and plurality of switches 786. Touch pad 784 and switches 786 may be operatively coupled to wireless transmitter 788. Wireless transmitter 788 may be configured to transmit information over a wireless communication link so that an electronic device that has receiving capabilities may receive the information over the wireless communication link. Wireless transmitter 788 may be widely varied. For example, it may be based on wireless technologies such as FM, RF, Bluetooth, 802.11 UWB (ultra wide band), IR, magnetic link (induction) and/or the like. In the illustrated embodiment, wireless transmitter 788 is based on IR. IR can generally refer to wireless technologies that convey data through infrared radiation. As such, wireless transmitter 788 can generally include IR controller 790. IR controller 790 can take the information reported from touch pad 784 and switches 786 and can convert this information into infrared radiation, as for example using light emitting diode 792.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The disclosure can be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in a plurality of units, or as part of other functional units. As such, the disclosure may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations are possible in view of the above teachings. The embodiments were chosen and described to explain the principles of the disclosure and their practical applications, and to enable others skilled in the art to best utilize the disclosure and various embodiments with various modifications as suited to the particular use contemplated.

What is claimed is:

1. A method for operating a user input device, comprising:
detecting a location of a user input using one or more touch sensors;
detecting a force of the user input using a switch; and
generating a signal for performing a task selected from a plurality of predefined tasks in accordance with the location and force of the user input.

2. The method of claim 1, wherein detecting a location of a user input comprises:
determining the location of the user input using a polar coordinate system, wherein the location of the user input is represented by a distance and an angular position from a reference point.

3. The method of claim 1, wherein detecting a location of a user input further comprises:
determining the location of the user input using an X-Y grid, wherein the location of the user input is represented by a horizontal distance and a vertical distance from a reference point.

4. The method of claim 1, wherein detecting a location of a user input comprises:
selecting a size for the one or more touch sensors to achieve a corresponding signal-to-noise ratio generated by the one or more touch sensors.

5. The method of claim 1, wherein detecting a location of a user input comprises:
arranging the touch sensors into multiple regions; and
interpolating the location of the user input using immediate touch sensors surrounding the user input and secondary neighbor touch sensors.

6. The method of claim 5 further comprising:
arranging the touch sensors into multiple angular regions;
computing one or more threshold lines identifying the multiple angular regions; and
determining the location of the user input in one of the angular regions using the threshold lines.

7. The method of claim 5 further comprising:
arranging the touch sensors into multiple concentric regions;
computing one or more threshold lines identifying the multiple concentric regions; and
determining the location of the user input in one of the concentric regions using the threshold lines.

8. The method of claim 1, wherein detecting a force of the user input comprises:
determining the force of the user input using a gimbaled plate, a flexible member, and a supportive surface,
wherein the flexible member deforms asymmetrically when the force of the user input exceeds a first activation threshold of the flexible member and is applied near a side of the gimbaled plate, and
wherein the flexible member deforms symmetrically when the force of the user input exceeds a second activation threshold of the flexible member and is applied near the center of the gimbaled plate.

9. The method of claim 1, wherein detecting force of the user input further comprises:
determining the force of the user input using two dome switches configured to implement a gimbaled button.

10. A user input device, comprising:
one or more touch sensors configured to detect a location of a user input;
a switch configured to detect a force of the user input; and
a processor configured to generate a signal for performing a task selected from a plurality of predefined tasks in accordance with the force and location of the user input.

11. The user input device of claim 10, wherein:
the one or more touch sensors are located near the surface of the switch, and wherein the touch sensors are arranged in at least one of circular, oval, square, rectangular, and triangular shapes.

12. The user input device of claim 10, wherein:
the one or more touch sensors comprise at least one of capacitive, resistive, surface acoustic wave, pressure, and optical sensors.

13. The user device of claim 10, wherein the switch comprises:
a gimbaled plate;
a flexible member, wherein the flexible member is located beneath the gimbaled plate and is configured to deform in response to the force of the user input; and
a supportive surface arranged to support the flexible member and the gimbaled plate.

14. The user device of claim 13, wherein
the flexible member deforms asymmetrically when the force of the user input exceeds a first activation threshold of the flexible member and is applied near a side of the gimbaled plate, and
the flexible member deforms symmetrically when the force of the user input exceeds a second activation threshold of the flexible member and is applied near the center of the gimbaled plate.

15. The user device of claim 10, wherein the switch further comprises:
a center button arranged on top of a first dome switch;
a circular click wheel coupled to the center button;
a stiffener arranged beneath the first dome switch and the circular click wheel;
a second dome switch arranged to support the stiffener and located beneath the first dome switch; and
a gimbaled plate coupled to the second dome switch.

16. The user input device of claim 10, wherein the processor comprises at least one of central processing unit (CPU), digital signal processor (DSP), application-specific integrated circuit (ASIC), and field-programmable gate array (FPGA).

17. The user input device of claim 10, wherein the plurality of predefined tasks comprise tasks defined by Menu, Forward, Back, Play, Stop, Pause, and Select of an MP3 player.

18. The user input device of claim 10, wherein the plurality of predefined tasks comprise tasks defined by buttons at the top, bottom, left, right, and center locations of the user input device.

19. A method for simulating multiple push buttons in a user input device, comprising:
detecting a location of a user input using one or more touch sensors;
detecting a force of the user input using a switch; and
generating a signal for representing one of the push buttons being pressed in accordance with the location and force of the user input.

20. The method of claim 19, wherein detecting a location of a user input comprises:
arranging the touch sensors into multiple regions; and
interpolating the location of the user input using immediate touch sensors surrounding the user input and secondary neighbor touch sensors.

21. The method of claim 20 further comprising:
arranging the touch sensors into multiple angular regions for representing relative locations of the multiple push buttons;
computing one or more threshold lines identifying the multiple angular regions; and
determining the location of the user input in one of the angular regions using the threshold lines.

22. The method of claim 20 further comprising:
arranging the touch sensors into multiple concentric regions for representing relative locations of the multiple push buttons;
computing one or more threshold lines identifying the multiple concentric regions; and
determining the location of the user input in one of the concentric regions using the threshold lines.

23. The method of claim 19, wherein detecting a force of the user input comprises:
determining the force of the user input using a gimbaled button comprising a gimbaled plate, a flexible member, and a supportive surface,
wherein the flexible member deforms asymmetrically when the force of the user input exceeds a first activation threshold of the flexible member and is applied near a side of the gimbaled plate, and
wherein the flexible member deforms symmetrically when the force of the user input exceeds a second activation threshold of the flexible member and is applied near the center of the gimbaled plate.
